(19) United States
(12) Patent Application Publication
(10) Pub. No.: US 2014/0149192 A1
(43) Pub. Date: May 29, 2014

(54) VERIFICATION OF ONLINE ADVERTISEMENT SECURITY

(71) Applicant: MICROSOFT CORPORATION, Redmond, WA (US)

(72) Inventors: Hadas Bitran, Ramat Hasharon (IL); Haim Somech, Ramat Gan (IL); Ian Ferreira, Issaquah, WA (US); Jason White, Brooklyn, NY (US); Matthew Sullivan, Brooklyn, NY (US)

(73) Assignee: MICROSOFT CORPORATION, Redmond, WA (US)

(21) Appl. No.: 13/684,564

(22) Filed: Nov. 25, 2012

(51) Int. Cl. G06Q 30/02

(52) U.S. Cl. CPC G06Q 30/0241
USPC 705/14.4

(57) ABSTRACT

Online advertisements may be verified before being rendered. In one example, an ad control is incorporated into an application or web page. When the ad control is to present an ad, the ad control requests an ad from an ad provider. Upon receipt of the ad, the ad control generates one or more hashes from the ad, and may extract one or more landing pages from the ad. The ad control then submits the one or more hashes, and the URLs of the one or more landing pages, to a reputation service for verification. The reputation service may then determine whether the ad and/or its landing pages are acceptable, and returns an “OK” or “not OK” message accordingly. If the ad and its landing pages are determined to be acceptable, then the ad control renders the ad. Otherwise, the ad control requests a new ad from the ad provider.

### BACKGROUND

Advertisements are often delivered with web services as a way of monetizing the web service. The provider of a web service may include an iframe within the content that is delivered to a user. The iframe retrieves an ad from an ad server and renders the ad while the user is viewing the service's content. For example, the user may visit the service's web page, or may invoke the service's smart phone application, and an ad may be rendered on the user's device along with the service's content.

Typically, the ad is chosen dynamically rather than being a fixture of the service's content. Thus, it is often the case that neither the provider of the web service, nor the end user of that service, knows what ad content is going to be rendered when the user downloads the service's web page or invokes the service's application. Downloading unknown content may present security issues.

Certain web pages provide an iframe element in which an ad is rendered. Since the iframe provides some measure of isolation, ads that can be rendered only within an iframe mitigate some of the security concerns associated with rendering arbitrary, unknown content. However, there are certain contexts where an iframe is not used to isolate the ad content.

### SUMMARY

Ads may be verified for security prior to being rendered. A content provider may put an ad control into content, where the ad control retrieves and renders an ad while the user is using the content. When the ad control receives the ad, it may generate a hash of the ad, or of individual assets within the ad. The hash may then be sent to a reputation service for verification.

If the reputation service recognizes the hash as being associated with a verified ad, and the verification has not expired, then the reputation service notifies the ad control that the ad is safe to render. The ad control then proceeds to render the ad. If the reputation service does not recognize the hash, or recognizes the hash as being associated with an unsafe ad, or recognizes the hash as being associated with a previously verified ad whose verification has exceeded its time-to-live (TTL), then the reputation service advises the ad control that the ad is not safe to render. The ad control then requests another ad, and the reputation service may add the unsafe ad to a queue for scanning and verification.

The reputation service may verify the entire ad as a single block, or may verify individual assets within the ad. For example, an ad may comprise text, Javascript, a video, a link to a “landing page,” etc. A reputation service may verify the entire ad, or may verify any of these assets separately. In one example, the landing page (the page to which the user would be pointed if the user clicks on a link in the ad) is verified separately from the actual content served by the ad control. The ad control may be configured to provide information to the reputation service in a manner appropriate for the reputation service's verification model. E.g., if the verification service verifies the individual ad assets and landing pages separately, then the ad control may be configured to recognize, and calculate hashes of, the individual assets, and to provide the Uniform Resource Locators (URLs) of the landing pages. A specific ad control may insist that the ads its serves conform to a specific template that governs what types of assets may be in the ad. (Any type of assets may be scanned, but—when a template is used—it may be that only certain types of assets will be allowed to be rendered by the ad control.)

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example device on which an ad may be rendered.

FIG. 2 is a block diagram of an example system in which ads may be requested and verified.

FIG. 3 is a block diagram of an example reputation service.

FIG. 4 is a flow diagram of an example process by which a program renders an ad.

FIG. 5 is a flow diagram of an example process that may be carried out by a reputation service.

FIG. 6 is a block diagram of example components that may be used in connection with implementations of the subject matter described herein.

### DETAILED DESCRIPTION

Online services often render advertisements (“ads”), along with the content that the services provide, as a way of generating revenue. Services such as weather reports, television listings, or online board games may generate revenue by allowing ads to be rendered along with the content that the user wants to see. For example, the user of an online board game may see both the game and a third-party ad for a retail site. An ad typically generates revenue for the service operator when a user clicks on the ad (although other business models—such as cost per thousand (CPM) advertising—may be used).

When online services are delivered through a web site, typically the web page served by the web site contains a location in which advertising content may be rendered. For example, the page generated by the service may contain the service's content on the left side of the page, with a rectangle on the right side reserved for advertising content. The rectangle reserved for advertising is often implemented as a Hypertext Markup Language (HTML) iframe. The iframe calls an ad server, and the browser renders the ad inside the iframe.

But many web services are being provided in a way that is not amenable to the above model. For example, many users access web services on their smart phones or tablets through the service's application (“app”). Apps, like web pages, can have ad controls that cause ads to be displayed while the user is using the app. These apps typically are not implemented with HTML iframes, and often given the app developer relatively free reign to affect the user experience of his or her app on the device by deciding where to place the ad control. Moreover, a web page could have an ad control that is not bounded by an iframe. An ad contains content that is likely to be unknown both to the provider of the online service and the user of that service. Allowing such content to be rendered presents a risk to the quality of the user experience and, in many cases, a security risk.

The subject matter herein provides a way to verify ad content, so that ads are rendered only after they have been verified to meet certain conditions. In order to provide ads with content, the content provider (e.g., the operator of an online service) includes an ad control with the content. The ad control typically takes the form of code to be included within an app or web page. When the content is loaded, the ad control causes an ad to be retrieved and rendered. Typically, the ad control is provided by the service that will be used to place ads. E.g., Google may provide one ad control that retrieves ads from Google's advertising servers, and Microsoft may provide a different ad control that retrieves ads from Microsoft's advertising servers. The content provider decides which entity it wants to place ads with its content, and includes that entity's ad control in its content.

When the content is loaded on a user's device, the ad control contacts the appropriate ad server to request an ad. When the ad is received, the ad control may generate a hash (or other derivative value) from the ad that it receives. The ad control may generate a single hash for the entire ad, or may generate separate hashes for different assets. For example, an ad may contain components of text, Javascript, audio, video, links to “landing pages,” etc., and each of these components might be considered a separate asset. In one example, the ad control calculates a hash of the entire ad. In another example, the ad control calculates a hash of each asset. The ad control then sends the hash(es) to a reputation service. For reasons described below, landing pages (the page(s) to which the user would be taken if the user clicks on the ad) may present different security issues from the other parts of the ad. Therefore, in another example, the ad control may extract the Uniform Resource Locators (URLs) of the landing page(s) and may send these URLs to the reputation service separately from the hashes.

The reputation service maintains a list of hashes that represent ads (or individual ad assets) that are known to be acceptable. When an ad is encountered for the first time, the reputation service may perform various types of tests on the ad—e.g., tests for malware, tests for appropriateness of content, tests for compatibility with web pages, etc. If the ad content is acceptable, then the reputation service maintains the hash of the ad (or the hashes of the individual ad assets) on a whitelist. If the ad is not acceptable, then the ad may be put on a blacklist. There may be a “time to live” (TTL) for each hash on the whitelist, thereby forcing even ads that have already been verified to have their verification refreshed. The TTL may be different for different types of assets, or for different ads. Moreover, landing pages may be verified separately, and whitelists and blacklists of landing pages may also be maintained. (The landing page whitelist may also have a TTL associated with each landing page.)

If the ad content and landing page is deemed acceptable by the reputation service, then the reputation service notifies the ad control of this fact, and the ad control proceeds to render the ad. If the reputation service cannot approve the ad content, then the reputation service notifies the ad control of this fact, and the ad control requests another ad. The reputation service might find an ad to be unacceptable, either because the ad is known to be problematic (blacklisted), or because the ad is unknown to the reputation service, or because the ad was previously verified to be safe but the verification has exceeded its TTL.

Ads to be served by a particular ad control may have to conform to a particular template (or to one of several templates). The template may impose a structure on ads by specifying a particular format for an ad, or by specifying particular types of assets that may be included in an ad. For example, a template might specify that an ad may include text and still pictures, but not video or Javascript. Advertising services may provide the templates that may be used with their ad controls, or may certify third party templates for use with their ad control. The ad control may insist that the ad conforms to the template as a condition of rendering the ad.

It is noted that a system in which an ad control requests approval to render an ad from a reputation service is different from a system that constitutes only an advertising malware scanner. Malware scanners for use with advertisements typically remove ads that contain malware from the pool of ads to be served. By contrast, an ad control that is requesting approval from a reputation service has already been served with the ad, so the ad has not been removed from the pool of available ads. Moreover, in one example the reputation service does not seek to remove malware from ads, but simply identifies those ads that do have malware so that the ad control can decide whether to render the ads.

Additionally, it is noted that a system in which the ad control provides a hash of an ad (or other derivative value) to the reputation service is different from a system in which ads are certified as to their behavior and/or safety. In the former case, the ad control is able to ask the reputation service about the safety or acceptability of an arbitrary ad; in the later case, ads have to be pre-certified before the ad control can attempt to verify the ad's safety or acceptability.

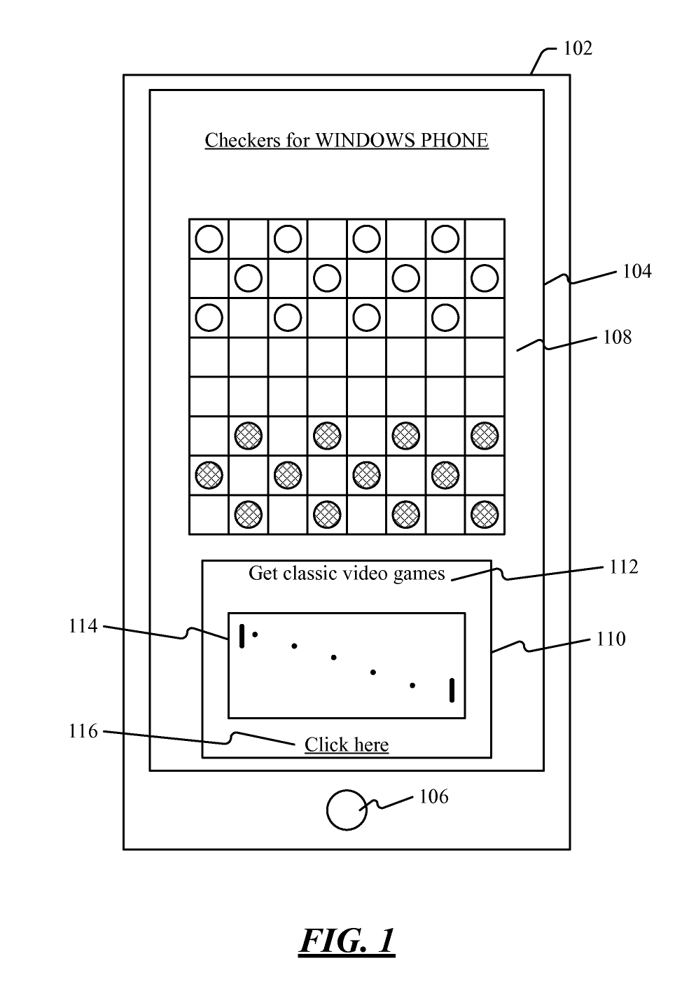

Turning now to the drawings, FIG. 1 shows an example device on which an ad may be rendered together with an online service's content. Device 102 may be a smart phone, tablet computer, personal computer, set top box, or any other device that has some computing capability. In the example shown, device 102 is depicted as a smart phone, although device 102 could be any appropriate type of device. Device 102 may have various input and output devices, such as display 104 (which may be a touch screen) and home button 106, which allow a user to interact with device 102.

In the example shown, an app 108 called “Checkers for WINDOWS PHONE” is running on device 102. App 108 is an example of an app that facilitates the use of an online service. An opponent in the checkers game shown may be played by a server computer operated by an online game service. Or, the online game service may facilitate game play between human opponents who are distant from each other. In either case, app 108 is facilitating the use of an online service, and the operator of that service might want to monetize the service through the use of ads. While a game service is shown in the example of FIG. 1, it is noted that the service in question could provide weather, maps, search, mathematical equation solving, airline flight information, or could be any other type of service.

In order to monetize the underlying service through the use of ads, the provider of app 108 may include an ad control within app 108. Ad control causes app 108 to display ads on device 102. Ad 110 is an example of such an ad. In the example shown, ad 110 has a text message 112 (“Get classic video games”), a video 114 (showing the classic game “pong” being played), and a link 116, which points to a “landing page” for the ad. In the example of FIG. 1, ad 110 is shown as being a visual banner ad that is located in a rectangular boundary. However, the ad control may have the ability to affect, arbitrarily, the user's experience on device 102. That is, the ad control might have the technical ability to overlay an ad over the entire display 104 (instead of keeping the ad within a discrete rectangle), to play audio through the speakers, to invoke mechanical functions on the device such as vibration, or to invoke another application on the device. Thus, the ad control can interfere with the user's experience, and might even be able to compromise the security of the device, depending on what type of advertising content ad control serves. An ad control that causes offensive or dangerous ads to be rendered may be less likely to be adopted by ad developers, and may also compromise people's opinion of the platform on which app 108 operates. (E.g., people may have a negative opinion of a particular smart phone operating system if, while using such a system, they often receive offensive or destructive ads.) Thus, the operator of ad control, and the distributor of device 102's platform, may have an incentive to verify ads before they are rendered.

It will be understood that app 108 is an example of content that may contain an ad control that delivers an ad. A web page that is rendered by a browser is also an example of such content. Thus, ad 110 might be rendered as part of a web page. Moreover, all of the discussion herein concerning ad controls that operate with apps applies equally to ad controls that operate with web pages.

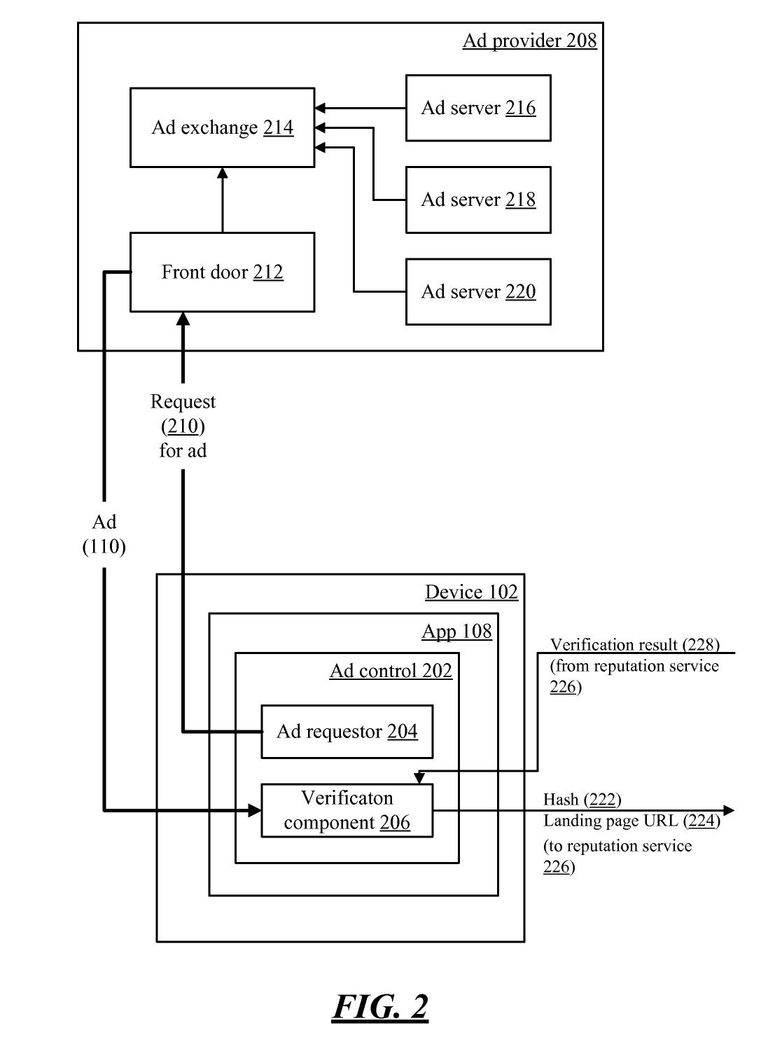

FIG. 2 shows an example system in which ads may be requested and verified. App 108 runs on device 102. (Both app 108 and device 102 are described above in connection with FIG. 1.) App 108 includes ad control 202, which obtains and renders ads on device 102 while a user is using app 108. Ad control 202 may comprise an ad requestor 204 and a verification component 206. Ad requestor 204 is a component that requests an ad from an ad provider 208. Verification component 206 participates in the verification of ads that are provided by ad provider 208, by generating one or more hashes (or other derived values) from the ad that ad provider 208 returns, by extracting landing page information, and by sending the derived values and landing page information to a reputation service. Ad control 202, ad requestor 204, and verification component 206 may be implemented as software that executes on device 102.

When an ad is to be rendered, ad control 202 causes ad requestor 204 to submit a request 210 for an ad to ad provider 208. Ad provider 208 may use any type of underlying infrastructure to provide an ad. One example infrastructure is shown in FIG. 2. Ad provider 208 may have a front door 212 that receives ad request 210, and that provides the requested ads. Front door 212 may contact an ad exchange 214, which obtains ads from several ads servers 216, 218, and 220. For example, ad servers 216-220 may be operated by various different organizations that accept ads from publishers for placement, and ad exchange may obtain ads from these servers in order to serve ads in response to requests. While the structure of ad provider 208 shown in FIG. 2 is one example of how an ad provider may be organized, the subject matter herein may use any ad provider, regardless of what underlying structure it uses to provide ads.

In response to request 210, ad provider 208 provides an ad 110 to ad control 202. The ad 110 is received by ad control 202's verification component 206. Verification component 206 may participate in the verification of ad 110 in various ways. One such way is that verification component 206 may determine whether the ad conforms with a particular template. As discussed above, the provider of ad control 202 may provide one or more templates (or may certify one or more templates created by third parties), and may impose the condition that ads to be rendered by ad control 202 are to satisfy at least one of the approved templates. A template may specify the approved format of an ad, or may specify what types of assets (e.g., text, video, audio, Javascript, etc.) may, or may not, be within an approved ad. Thus, verification component may verify that the ad it has received conforms to the template.

Another way in which verification component 206 may participate in verification of ad 110 is that verification component 206 may create one or more derived values (e.g., hashes) from ad 110. In one example, verification component 206 creates a hash based on the entire ad 110. In another example, verification component creates separate hashes of the individual assets of ad 110—e.g., verification component may create a separate hash for each video, for each audio clip, for each code module, etc. Verification component 206 may create both types of hashes—e.g., one hash for the entire ad, and one or more additional hashes for some or all of the individual assets of the ad.

Another way in which verification component 206 may participate in verification of ad 110 is to extract the URL(s) of the landing page(s) in ad 110. When verifying the security of an ad, the landing page and the ad assets may represent different types of risks to be evaluated differently. In particular, any change in an ad (or in its constituent assets) can be detected through a hash, since any change in the ad or asset is very likely to produce a change in the hash. On the other hand, the landing page is identified by its URL, and the page pointed to by that URL can change frequently without any change to the URL. For these reasons, the safety of ad assets and the safety of landing pages may be evaluated by different processes and under different criteria, so verification component 206 may separate out the URLs of the landing pages from ad 110, so that the landing pages can be evaluated separately from the ad assets themselves.

Once verification component 206 has calculated the relevant hash(es) and extracted the relevant URL(s), verification component 206 sends the hash 222 and URL 224 to reputation service 226. Reputation service 226 returns a verification result 228. Result 228 provides an indication either that ad control 202 may render the ad (“OK”) or may not render the ad (“not OK”). Reputation service 226 may employ any appropriate criteria in determining which result to return. In one example, reputation service approves the rendering of the ad if the ad has previously been evaluated, is on reputation service 226's whitelist, and has a non-expired TTL. If the ad is unknown, or is on reputation service 226's blacklist, or is on the whitelist with an expired TTL, then reputation service 226 may disapprove of the ad. Regardless of how reputation service 226 makes its decision to approve or disapprove the ad, ad control 202 may obey the result 228 that it receives and may act accordingly. If ad control 202 receives a “not OK” from reputation service 226, then ad control 202 may request another ad from ad provider 208, which it may then verify again in the manner described above.

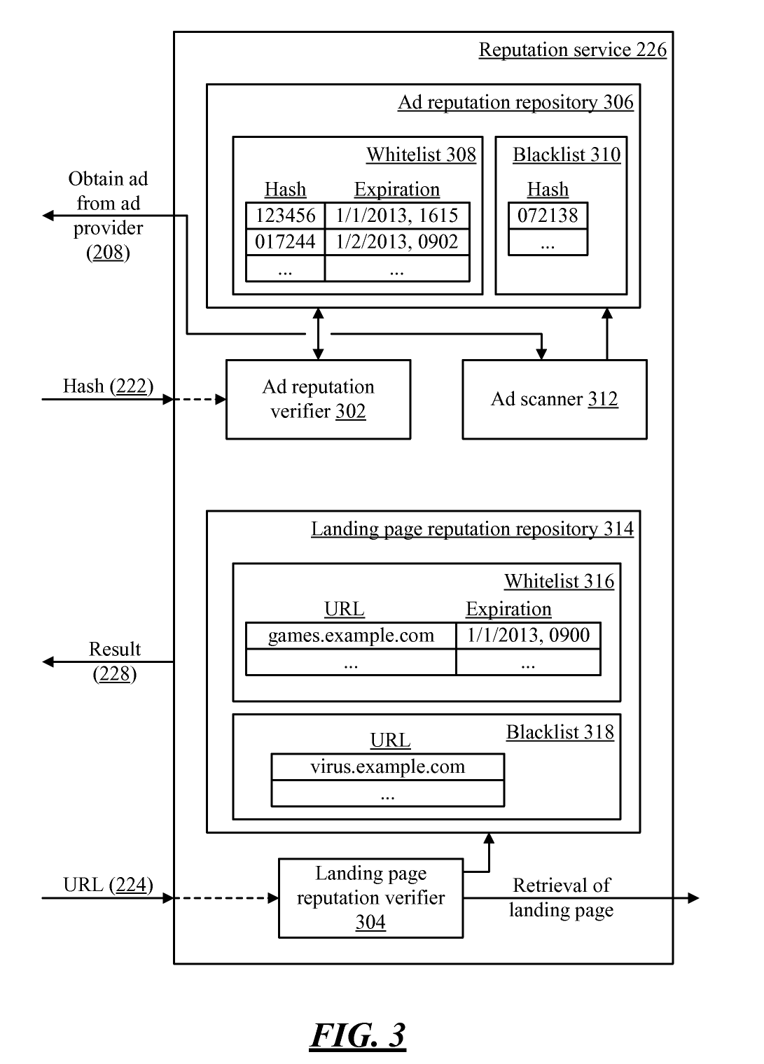

FIG. 3 shows an example of reputation service 226.

As described above, reputation service 226 receives a hash 222 and a landing page URL 224 from an ad control, and responds by providing a result 228 that indicates whether the underlying ad, and its landing page, are acceptable. In order to provide this result to the ad control, reputation service 226 may employ an ad reputation verifier 302 and a landing page reputation verifier 304. Ad reputation verifier 302 may maintain an ad reputation repository 306, which contains a whitelist 308 and a blacklist 310 of “good” and “bad” hashes, respectively. Each hash in whitelist 308 or blacklist 310 may represent an entire ad, or individual assets of an ad. Whitelist 308 contains a list of hashes. (The hashes in whitelist 308 are shown, in this example, as six-digit numbers, although hashes could be represented in any manner.) For each hash in whitelist 308, an expiration date and time is shown. The expiration date is based on the TTL associated with an ad or an ad asset. For example, when an ad or ad asset is verified, the verification may be presumed to be valid for a day, three days, a week, or any appropriate amount of time. This amount of time for which a verification is considered valid is the hash's time-to-live, and the expiration date of the hash may be set accordingly. Blacklist 310 also contains a list of hashes, representing those ads or ad assets that are known to be problematic. Blacklist 310 might not have expiration dates associated with the hashes; rather, a “bad” ad or asset on blacklist 310 might be presumed to maintain its “badness” indefinitely, until such time (if ever) that the ad or asset is removed from blacklist 310.

When ad reputation verifier 302 receives hash 222, it looks up hash 222 in whitelist 308 and/or blacklist 310. If the hash is on whitelist 308 and is not expired, then ad reputation verifier 302 may conclude that the ad or asset associated with the hash is acceptable. If the hash represents the entire ad, then ad reputation verifier 302 may be able to conclude that the underlying ad is acceptable by checking only one hash. In the example in which the ad control provides separate hashes for each of the individual ad assets, then ad reputation verifier 302 may check all of the hashes against whitelist 308 and/or blacklist 310, and might conclude that the underlying ad is acceptable only if all of the hashes appear in whitelist 308 and are non-expired. Any hash that appears on blacklist 310 would cause ad reputation verifier 302 to conclude that the ad is not acceptable.

Any ad whose hash does not appear on either whitelist 308 or blacklist 310 (or that contains an asset whose hash does not appear on whitelist 308 or blacklist 310) would be presumed to be an unknown ad. Ad reputation verifier 302 would indicate to the ad control that such an ad is unacceptable, but may queue the underlying ad for verification so that it can be approved if the ad provider attempts to serve the same ad again. (Since it would likely take several seconds or minutes to evaluate an ad, it is faster to ask the ad control to get another ad rather than trying to evaluate a new ad in real-time.) Ad scanner 312 scans ads to determine whether they are to be placed on whitelist 308 (if acceptable) or on blacklist 310 (if unacceptable). Scanner 312 may perform various evaluations on ads and their assets, such as checks for malware, checks for appropriateness of content, checks to verify compliance with the ad control publisher's rules, or other types of checks. Ad scanner 312 may perform this verification in response to reputation service 226's encountering of an ad (or ad asset) that it has not seen before, by obtaining the ad in question from provider 208. Or, the creator or provider of an ad may submit an ad (or ad asset) to reputation service 226 to be scanned, in order to expedite approval of the ad when subsequent attempts are made to serve the ad.

In addition to verifying an ad or ad asset, reputation service 226 may also verify a landing page contained in an ad. As mentioned above, verification of landing pages may present issues that are different from verification of ad assets: landing pages can change frequently, even though their URLs do not change. Thus verification of a landing page may involve visiting the landing page frequently and evaluating the landing page's content and behavior. Thus, the ad control may extract the landing page (or pages) from an ad, and may submit the URL 224 of a landing page separately from the hash of the underlying ad. Landing page reputation verifier 304 may maintain a landing page reputation repository 314, which has a whitelist 316 and/or a blacklist 318. Whitelist 316 contains a list of URLs whose content has been approved, and the expiration dates of those approvals. The TTL for the approval of a landing page may be very short, since landing pages can be changed easily and frequently. Thus, landing pages may have to be re-verified frequently. Blacklist 318 contains a list of URLs whose content has been found unacceptable. As with blacklist 310, the items in blacklist 318 might not have expiration dates, since a blacklisted URL might be considered “bad” indefinitely until removed from blacklist 318.

In order to evaluate landing pages, landing page reputation verifier 304 may visit (or may cause some other component to visit) any landing pages that are encountered by ad controls and that are submitted to reputation service 226 for verification. Thus, if an ad control submits the URL of a landing page that has not previously been seen by reputation service 226, then landing page reputation verifier may queue the URL to be visited and analyzed to determine whether it belongs on whitelist 316 or blacklist 318.

When reputation service 226 has evaluated both the hash 222 (or plural hashes, if hashes for the separate assets are submitted) and the landing page URL 224, it may return a result 228 indicating whether the ad and its landing page are acceptable.

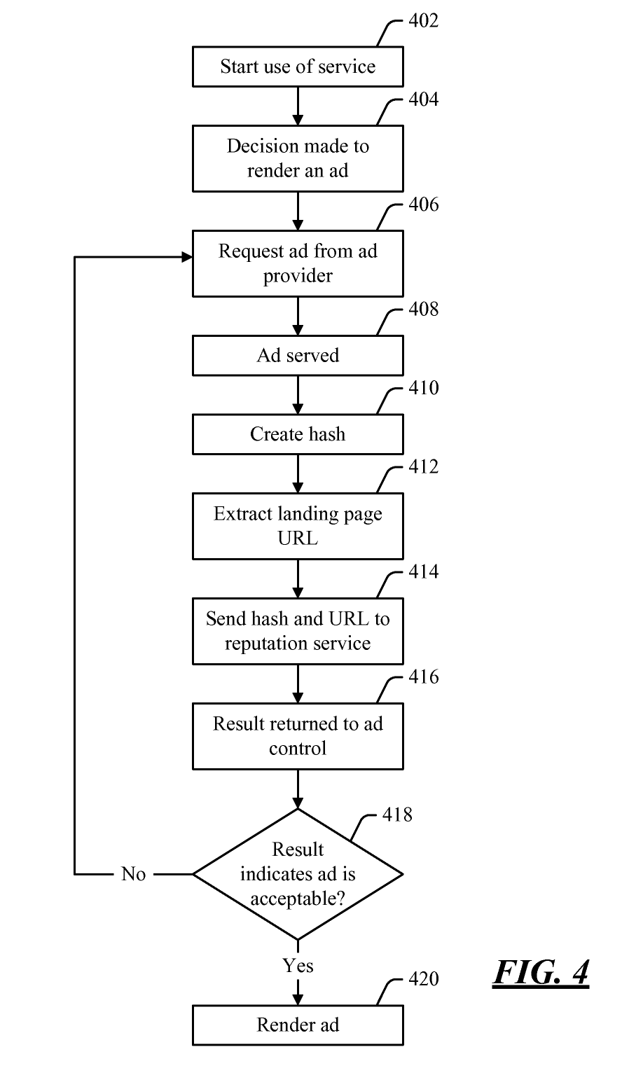

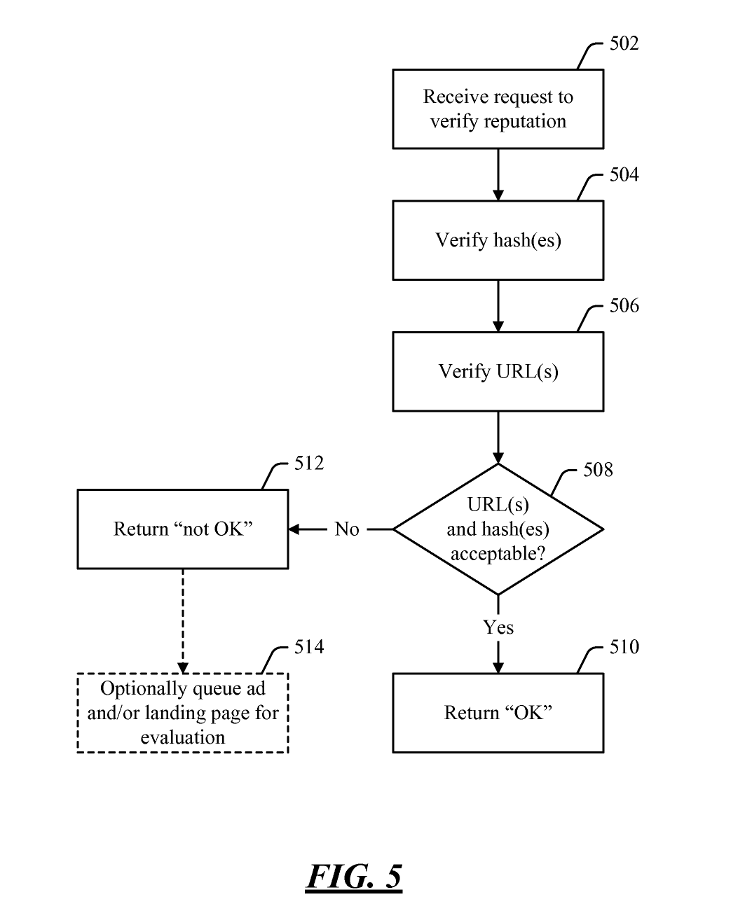

FIG. 4 shows an example process by which a program renders an ad. Before turning to a description of FIG. 4, it is noted that the flow diagrams contained herein (both in FIG. 4 and in FIG. 5) are described, by way of example, with reference to components shown in FIGS. 1-3, although the processes of FIGS. 4 and 5 may be carried out in any system and are not limited to the scenarios shown in FIGS. 1-3. Additionally, each of the flow diagrams in FIGS. 4 and 5 shows an example in which stages of a process are carried out in a particular order, as indicated by the lines connecting the blocks, but the various stages shown in these diagrams can be performed in any order, or in any combination or sub-combination.

At 402, the use of a service is started. The service may be an online service, such as a game, weather reporting service, flight status service, or any other type of service. Starting the use of a service may be performed by invoking the app that is used to access the service, or may be performed by visiting the service's web page through a browser.

At some point during the use of the service, a decision may be made to render an ad (at 404). This decision may be made by the ad control that is incorporated into the app or web page through which the user is accessing the service. A request for an ad is made to an ad provider (at 406), and the ad provider responds by serving an ad to the requestor (at 408). The ad may be chosen based on the type of content with which the user is interacting (e.g., serving an ad for a game while a user is playing a different game), based on the user's history, or based on any other appropriate considerations. (If the ad is chosen based on information specific to the user, appropriate permission may be obtained in order to protect the user's interest in privacy.)

At 410, a hash of the ad (or hashes of the individual ad assets) may be created. At 412, the URL(s) of the landing page(s) may be extracted from the ad. The hash(es) and URL(s) may then be sent to the reputation service (at 414). The calculation of the hash, the extraction of the URL, and the sending of the hash and URL to the reputation service may be performed by the ad control. The reputation service then determines whether the ads and/or landing pages are acceptable, and returns a result to the ad control (416).

If the result returned by the reputation service indicates the ad is acceptable (as determined at 418), then the ad control renders the ad at 420. If the result returned indicates that the ad is not acceptable, then the process returns to 406, so that the ad control may request another ad.

FIG. 5 shows an example process that may be carried out by a reputation service.

At 502 a request to verify the reputation of an ad is received from an ad control. The request may include a hash of the ad (or hashes of the individual assets within the ad), and the URL(s) of the landing page(s) contained in the ad. At 504, the hash(es) may be verified. The verification may be performed by comparing the hash(es) with a whitelist and/or blacklist, as described above in connection with FIG. 3. At 506, the URL(s) may be verified (e.g., by comparing the URL(s) with a whitelist and/or blacklist). If the hash(es) and URL(s) are found to be acceptable (as determined at 508), then the reputation service may return an “OK” message to the ad control (at 510). Otherwise, the reputation service may return a “not OK” message to the ad control (at 512). If a “not OK” message is returned because the ad was unknown to the reputation service (as opposed to the ad having been blacklisted due to a previous determination that the ad is problematic), then the reputation service may queue the unknown ad for evaluation (at 514).

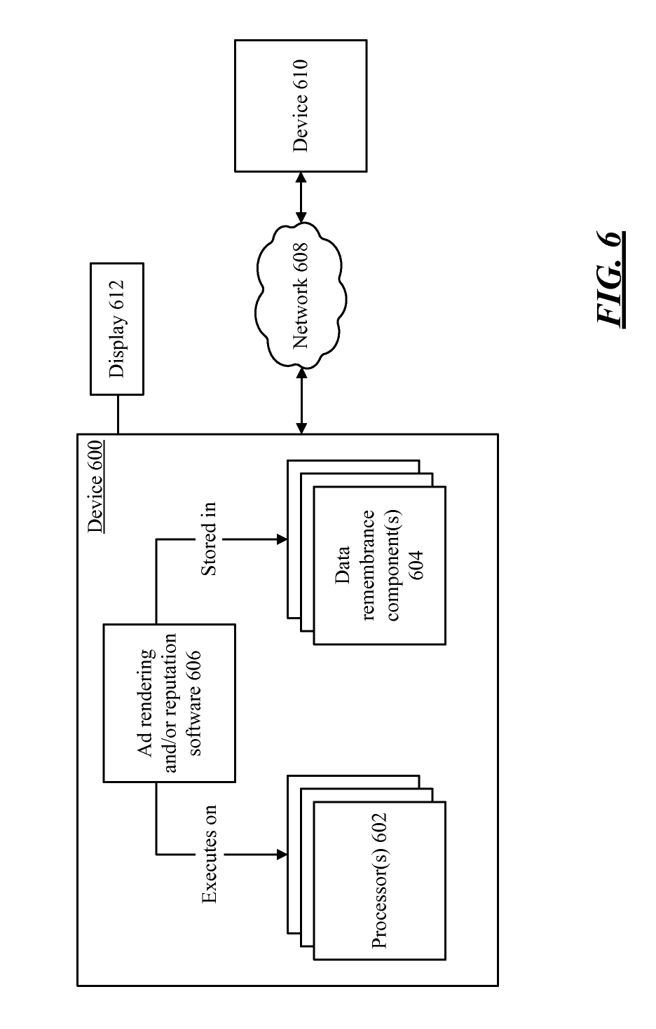

FIG. 6 shows an example environment in which aspects of the subject matter described herein may be deployed.

Device 600 includes one or more processors 602 and one or more data remembrance components 604. Device 600 may be any type of device with some computing power. A smart phone is one example of device 600, although device 600 could be a desktop computer, laptop computer, tablet computer, server computer, set top box, or any other appropriate type of device. Processor(s) 602 are typically microprocessors, such as those found in a personal desktop or laptop computer, a server, a handheld computer, or another kind of computing device. Data remembrance component(s) 604 are components that are capable of storing data for either the short or long term. Examples of data remembrance component(s) 604 include hard disks, removable disks (including optical and magnetic disks), volatile and non-volatile random-access memory (RAM), read-only memory (ROM), flash memory, magnetic tape, etc. Data remembrance component(s) are examples of computer-readable (or device-readable) storage media. Device 600 may comprise, or be associated with, display 612, which may be a cathode ray tube (CRT) monitor, a liquid crystal display (LCD) monitor, or any other type of monitor. Display 612 may be an output-only type of display; however, in another non-limiting example, display 612 may be (or comprise) a touch screen that is capable of both displaying and receiving information.

Software may be stored in the data remembrance component(s) 604, and may execute on the one or more processor(s) 602. An example of such software is search and ad rendering and/or reputation software 606, which may implement some or all of the functionality described above in connection with FIGS. 1-5, although any type of software could be used. Software 606 may be implemented, for example, through one or more components, which may be components in a distributed system, separate files, separate functions, separate objects, separate lines of code, etc. A device (e.g., smart phone, personal computer, server computer, handheld computer, tablet computer, set top box, etc.) in which a program is stored on hard disk, loaded into RAM, and executed on the device's processor(s) typifies the scenario depicted in FIG. 6, although the subject matter described herein is not limited to this example.

The subject matter described herein can be implemented as software that is stored in one or more of the data remembrance component(s) 604 and that executes on one or more of the processor(s) 602. As another example, the subject matter can be implemented as instructions that are stored on one or more device-readable media. Such instructions, when executed by a phone, computer, or other machine, may cause the phone, computer, or other machine to perform one or more acts of a method. The instructions to perform the acts could be stored on one medium, or could be spread out across plural media, so that the instructions might appear collectively on the one or more computer-readable (or device-readable) media, regardless of whether all of the instructions happen to be on the same medium. The terms “computer-readable media” and “device-readable media” do not include signals per se. Additionally, it is noted that “hardware media” or “tangible media” include devices such as RAMs, ROMs, flash memories, and disks that exist in physical, tangible form; such “hardware media” or “tangible media” are not signals per se. Moreover, “storage media” are media that store information. The term “storage” is used to denote the durable retention of data. For the purpose of the subject matter herein, information that exists only in the form of propagating signals is not considered to be “durably” retained. Therefore, “storage media” include disks, RAMs, ROMs, etc., but does not include information that exists only in the form of a propagating signal because such information is not “stored.”

Additionally, any acts described herein (whether or not shown in a diagram) may be performed by a processor (e.g., one or more of processors 602) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, device 600 may be communicatively connected to one or more other devices through network 608. Device 610, which may be similar in structure to any of the examples of device 600, is a kind of device that can be connected to device 600, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of presenting an advertisement, the method comprising:
using a processor to perform acts comprising:
requesting said advertisement from a provider;
receiving said advertisement from said provider;
calculating a hash based on said advertisement;
sending said hash to a reputation service that determines, based on information comprising said hash, whether said advertisement is acceptable or not acceptable;
receiving, from said reputation service, an indication of whether said advertisement is acceptable or not acceptable; and
either rendering, or determining not to render, said advertisement based on said indication.

2. The method of claim 1, said advertisement comprising a landing page, said acts further comprising:
extracting a Uniform Resource Locator (URL) of said landing page from said advertisement; and
sending said URL to said reputation service for verification, the information used by said reputation service to determine whether said advertisement is acceptable or not acceptable further comprising a verification of said URL by said reputation service.

3. The method of claim 1, said advertisement comprising a plurality of assets, said acts further comprising:
calculating separate hashes for each of said assets, said hash being one of said hashes and being based on one of said assets, the information used by said reputation service to determine whether said advertisement is acceptable or not acceptable comprising all of said hashes.

4. The method of claim 1, said acts further comprising:
verifying that said advertisement satisfies a template that specifies what types of assets may be included in said advertisement.

5. The method of claim 1, said indication being that said advertisement is acceptable to said reputation service, said acts further comprising:
rendering said advertisement.

6. The method of claim 1, said indication being that said advertisement is not acceptable, said acts further comprising:
requesting a different advertisement from said provider.

7. The method of claim 1, said advertisement being determined by said reputation service to be unknown, said advertisement being queued by said reputation service for evaluation based on said advertisement being unknown to said reputation service.

8. A device-readable medium that stores executable instructions for presenting an advertisement, the executable instructions, when executed by a device, causing the device to perform acts comprising:
requesting said advertisement from a provider;
receiving said advertisement from said provider;
calculating a derived value from said advertisement;
sending said derived value to a reputation service that determines, based on information comprising said derived value, whether said advertisement is acceptable or not acceptable;
receiving, from said reputation service, an indication of whether said advertisement is acceptable or not acceptable; and
either rendering, or determining not to render, said advertisement based on said indication.

9. The device-readable medium of claim 8, said advertisement comprising a landing page, said acts further comprising:
extracting a Uniform Resource Locator (URL) of said landing page from said advertisement; and
sending said URL to said reputation service for verification, said reputation service determining whether said advertisement is acceptable or not acceptable further based on verification of said URL.

10. The device-readable medium of claim 8, said advertisement comprising a plurality of assets, said acts further comprising:
calculating separate derived values for each of said assets, said derived value being one of said derived values and being based on one of said assets, said reputation service using all of said derived values to determine whether said advertisement is acceptable or not acceptable.

11. The device-readable medium of claim 8, there being a template that specifies what types of assets may be included in said advertisement, said acts further comprising:
verifying that said advertisement satisfies said template.

12. The device-readable medium of claim 8, said reputation service indicating that that said advertisement is acceptable, said acts further comprising:
rendering said advertisement.

13. The device-readable medium of claim 8, said reputation service indicating that said advertisement is not acceptable, said acts further comprising:
requesting a different advertisement from said provider.

14. The device-readable medium of claim 8, said advertisement being determined by said reputation service to be unknown, said advertisement being queued by said reputation service for evaluation based on said advertisement being unknown to said reputation service.

15. A device that presents an advertisement, said device comprising:
a memory;
a processor;
a display; and
an application that is stored in said memory, that executes on said processor, and that comprises an ad control, said ad control requesting said advertisement from a provider, said ad control calculating a hash based on said advertisement, said ad control sending said hash to a reputation service that uses information comprising said hash to determine whether said advertisement is acceptable or not acceptable, said ad control receiving from said reputation service an indication that said advertisement is acceptable or not acceptable, said ad control determining whether to render said advertisement on said display based on whether said reputation service indicates that said advertisement is acceptable or not acceptable.

16. The device of claim 15, said advertisement comprising a landing page, said ad control extracting a Uniform Resource Locator (URL) of said landing page from said advertisement and sending said URL to said reputation service for verification, said reputation service determining whether said advertisement is acceptable or not acceptable based on verification of said URL by said reputation service.

17. The device of claim 15, said advertisement comprising a plurality of assets, said ad control calculating separate hashes for each of said assets, said hash being one of said hashes and being based on one of said assets, said reputation service using all of said hashes to determine whether said advertisement is acceptable or not acceptable.

18. The device of claim 15, said ad control verifying that said advertisement satisfies a template that specifies what types of assets may be included in said advertisement.

19. The device of claim 15, said ad control rendering said advertisement if said reputation service indicates that said advertisement is acceptable, said ad control requesting a different advertisement from said provider if said reputation service indicates that said advertisement is not acceptable.

20. The device of claim 15, said advertisement being determined by said reputation service to be unknown, said advertisement being queued by said reputation service for evaluation based on said advertisement being unknown to said reputation service.
